(19) United States
(12) Patent Application Publication
(10) Pub. No.: US 2009/0015077 A1
(43) Pub. Date: Jan. 15, 2009

(54) LINEAR MOTOR

(76) Inventors: Houng Joong Kim, Mito (JP); Hitoshi Shibata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/279,740

(22) PCT Filed: Mar. 31, 2006
(86) PCT No.: PCT/JP2006/307392

§ 371 Date: Aug. 18, 2008

(51) Int. Cl. H02K 41/02

(52) U.S. Cl. 310/12

(57) ABSTRACT

In prior art linear motor, magnetic attractive force acts in one direction between armature and moving member, imposing heavy burden on a supporting mechanism of the moving member, distorting the structure and causing various troubles. Furthermore, permanent magnets' surface is difficult to protect. The inventive linear motor includes a stator having armature winding and moving member having permanent magnets arranged to move relatively. The stator includes ring-like cores, armature teeth and armature winding to constitute a magnetic circuit. Slit grooves are disposed in the armature teeth opposite to both of obverse and reverse sides of the permanent magnets of the moving member through air gap and protrusion members movable along the slit grooves of the armature teeth and a member having a hollow part formed therein are provided. The permanent magnets are disposed in the hollow part so that magnetic poles adjoining along the moving direction have different polarities.

### TECHNICAL FIELD

The present invention relates to a linear motor and more particularly to a linear motor including primary-side members having ring-like cores, armature teeth and an armature winding constituting a magnetic circuit and secondary-side members having permanent magnets disposed in part of the ring-like cores through air gap to be reciprocated.

### BACKGROUND ART

A prior art linear motor has a main structure in which a rotor is cut open to be developed on a straight line and comprises a stator having an armature winding and a moving member supported to be able to be moved relatively to the stator through air gap. Accordingly, large magnetic attractive force acts between the stator and the moving member, so that a heavy burden is imposed on a supporting mechanism which maintains the air gap to be fixed and the whole apparatus is large in size.

A prior art linear motor has a main structure in which a rotor is cut open to be developed on a straight line and comprises a stator having an armature winding and a moving member supported to be able to be moved relatively to the stator through air gap. Accordingly, large magnetic attractive force acts between the stator and the moving member, so that a heavy burden is imposed on a supporting mechanism which maintains the air gap to be fixed and the whole apparatus is large in size.

Furthermore, in the prior art, a plurality of windings are wound on one stator unit and different windings are wound on adjacent stator magnetic poles, so that the structure of the whole apparatus is complicated.

It is an object of the present invention to solve the above defects by providing a linear motor having the compact structure by devising the arrangement method of an armature winding and the enhanced rigidity of secondary-side members (moving member) having permanent magnets while canceling magnetic attractive force acting between primary-side members (stator) and secondary-side members and maintaining the characteristics of a magnetic circuit and capable of being manufactured in a simple structure.

As a patent document concerning the prior art linear motor, International Patent Publication WO00/69051 may be referred to.

### DISCLOSURE OF THE INVENTION

In order to achieve the above object, according to the present invention, a linear motor includes a plurality of permanent magnets disposed along a moving direction and cores disposed opposite to both of obverse and reverse sides of the permanent magnets to form a closed magnetic path. Slit grooves are formed in armature teeth of the core and protrusion members are disposed to be able to be moved along the slit grooves. The protrusion members includes a hollow part formed therein and a plurality of members holding one or more permanent magnets are combined to be disposed in the hollow part so that magnetic poles adjoining along the moving direction have different polarities.

Furthermore, in order to achieve the above object, according to the present invention, a linear motor includes a plurality of permanent magnets disposed along a moving direction and cores disposed opposite to both of obverse and reverse sides of the permanent magnets to form a closed magnetic path. Slit grooves are formed in armature teeth of the core and protrusion members are disposed to be able to be moved along the slit grooves. The protrusion members includes a hollow part formed therein and magnetic members are disposed in the hollow part.

### BRIEF DESCRIPTION OF THE DRAWINGS

FIG. 1 illustrates basic structure of a linear motor according to an embodiment of the present invention;

FIG. 2 illustrates ring-like cores and arrangement of permanent magnets of the linear motor according to an embodiment of the present invention;

FIG. 3 illustrates the ring-like cores of the linear motor according to an embodiment of the present invention;

FIG. 4 illustrates a moving member of the linear motor according to an embodiment of the present invention;

FIG. 5 illustrates the moving member of the linear motor according to the embodiment of the present invention as compared with a moving member of a linear motor in the prior art;

FIG. 6 illustrates a permanent magnet component (part 1) of the linear motor according to an embodiment of the present invention;

FIG. 7 illustrates a permanent magnet component (part 2) of the linear motor according to another embodiment of the present invention;

FIG. 8 illustrates a permanent magnet component (part 3) of the linear motor according to another embodiment of the present invention;

FIG. 9 illustrates how to make (part 1) the moving member of the linear motor according to another embodiment of the present invention;

FIG. 10 illustrates how to make (part 2) the moving member of the linear motor according to another embodiment of the present invention;

FIG. 11 illustrates a core and a moving member (part 1) of the linear motor according to another embodiment of the present invention;

FIG. 12 illustrates a core and a moving member (part 2) of the linear motor according to another embodiment of the present invention; and

FIG. 13 is a schematic diagram illustrating a servo control system using the linear motor of the present invention.

### BEST MODE FOR CARRYING OUT THE INVENTION

Embodiments of the present invention are now described with reference to the accompanying drawing. In the drawings, the like reference numerals designate the like or equivalent constituent elements.

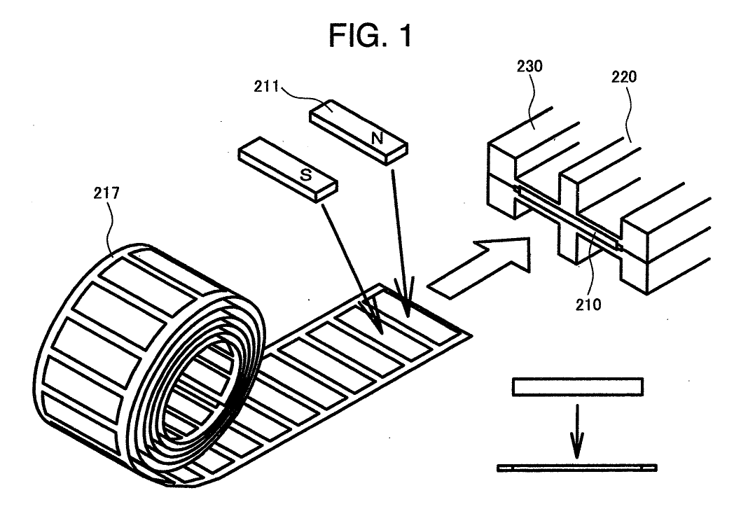

FIG. 1 illustrates basic structure of a linear motor according to an embodiment of the present invention.

In FIG. 1, protrusions 220 and a member 210 having a hollow part formed therein are provided and a plurality of permanent magnets are disposed in a third member 217 for keeping the permanent magnets 211 at regular intervals. The third member 217 and the permanent magnets 211 are disposed together in the hollow part.

The member 210 having the hollow part formed therein can be manufactured by aluminum extrusion simply and inexpensively. In this case, the member having the hollow part is manufactured as a single component by aluminum extrusion, although the member having the hollow part may be divided into a plurality of components to be manufactured by aluminum extrusion. When the member is divided into a plurality of components to be manufactured by aluminum extrusion, the plurality of permanent magnets 211 are disposed in the third member 217 for keeping the permanent magnets at regular intervals and then the plurality of divided components manufactured by aluminum extrusion can be combined and stuck.

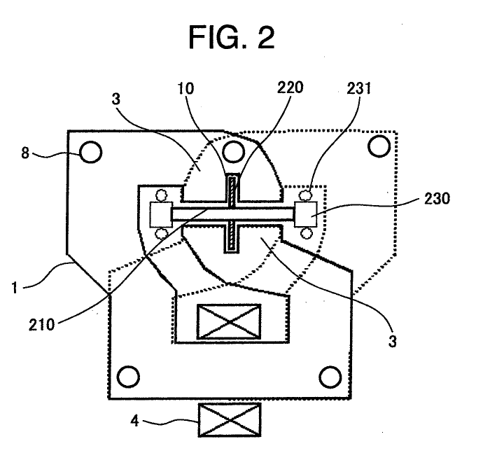

FIG. 2 illustrates basic structure of the linear motor according to an embodiment of the present invention.

In FIG. 2, the linear motor includes a stator constituting primary-side members having an armature winding 4 and a moving member 210 constituting secondary-side members having permanent magnets, which can be moved relatively. The basis system structure is the same as the contents described in the International Patent Publication WO00/69051 unless mentioned otherwise.

The stator of the linear motor includes ring-like cores 1, armature teeth 3 and the armature winding 4 to constitute a magnetic circuit. Slit grooves 10 are formed in the armature teeth 3 in part of the ring-like cores opposite to both of the obverse and reverse sides of the permanent magnets of the moving member through air gap and the protrusion members 220 are disposed on the permanent magnets to be able to be moved along the slit groove 10 of the armature teeth 3.

Moreover, the armature teeth 3 are disposed in part of the ring-like cores opposite to both of the obverse and reverse sides of the permanent magnets of the moving member 210 through air gap and guide rails 230 are disposed along the longitudinal direction of the moving member. Supporting mechanisms 231 are disposed on the side of the ring-like cores 1 in a corresponding manner to the guide rails 230. In order to assemble the plurality of ring-like cores 1, through-holes 8 are formed at part of the ring-like cores 1.

The supporting mechanisms 231 are disposed on both sides of the moving member 210, although the supporting mechanisms and guide rails (not shown) of the moving member may be combined in a mixed manner. Furthermore, as the supporting method thereof, a non-contact supporting method using aero static bearing or hydrostatic bearing or a supporting method using plane sliding or linear guide rails may be used.

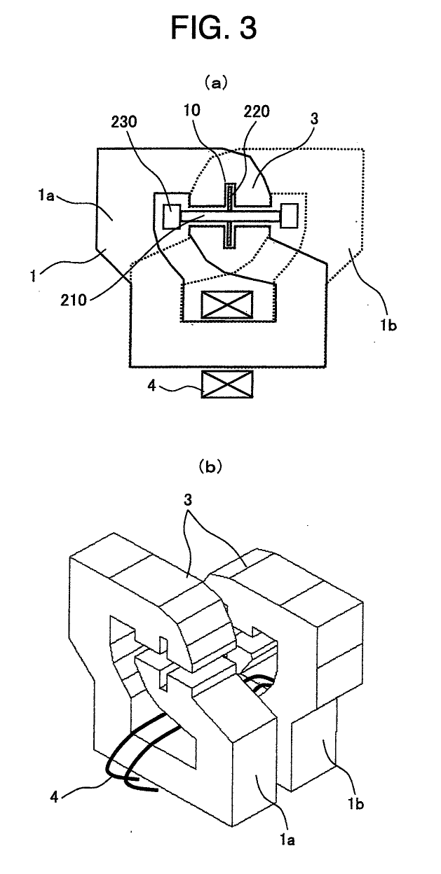

FIG. 3 schematically illustrates the ring-like cores of the linear motor according to the embodiment of the present invention.

In FIG. 3, the armature winding 4 is disposed or wound on an odd-numbered ring-like core 1a and an even-numbered ring-like core 1b in common. In FIG. 2(b), only 2 ring-like cores are shown, although one armature winding 4 may be wound on 2 or more odd-numbered ring-like cores and even-numbered ring-like cores.

Thus, a current flows through the single armature winding, so that magnetic fields in opposite directions can be formed between magnetic poles of adjacent cores.

Moreover, the armature winding 4 is not necessarily required to be wound on the ring-like cores in common to all of them in order to attain the effect as the linear motor and the armature winding may be disposed in any place as far as the moving member 210 can be moved freely. For example, instead of disposing the single armature winding 4 in the lower part of the ring-like cores 1, the single armature winding 4 may be disposed in vertically standing parts on both sides of the lower part of the ring-like cores 1 or 2 armature winding 4 may be disposed in both of the vertically standing parts on both sides of the lower part.

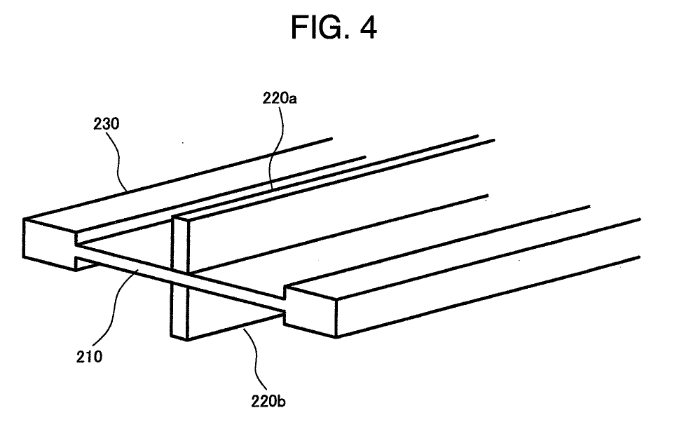

FIG. 4 illustrates the moving member of the linear motor according to the embodiment of the present invention.

In FIG. 4, the protrusion members 220a and 220b are disposed at center parts on both of the obverse and reverse sides of the moving member 210 and the guide rails 230 are disposed in the longitudinal direction of the moving member 210 on both sides thereof.

Thus, the protrusion members 220a and 220b are disposed at center parts on the obverse and reverse sides of the moving member 210 constituting the secondary-side members, so that the rigidity of the moving member can be enhanced even if the moving member of the secondary-side members is formed lengthwise in the longitudinal direction of the linear motor. Consequently, even if the moving member is moved at high speed, distortion of the moving member can be reduced.

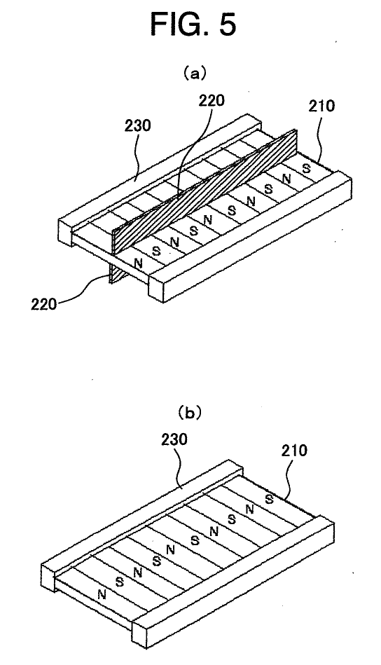

FIG. 5 illustrates the moving member of the linear motor according to the embodiment of the present invention as compared with a moving member of a linear motor in the prior art.

FIG. 5(a) illustrates the moving member of the linear motor of the present invention including the protrusion members 220 disposed at center parts on both of the obverse and reverse sides of the moving member 210 and FIG. 5(b) illustrates the moving member of the prior art linear motor without protrusion member disposed at center parts on both of the obverse and reverse sides of the moving member 210. In FIG. 5, the protrusion members 220 are disposed at center parts on both of the obverse and reverse sides of the moving member 210, so that the moment of inertia of area (sectional moment of the second order) of the moving member is increased and the rigidity is enhanced.

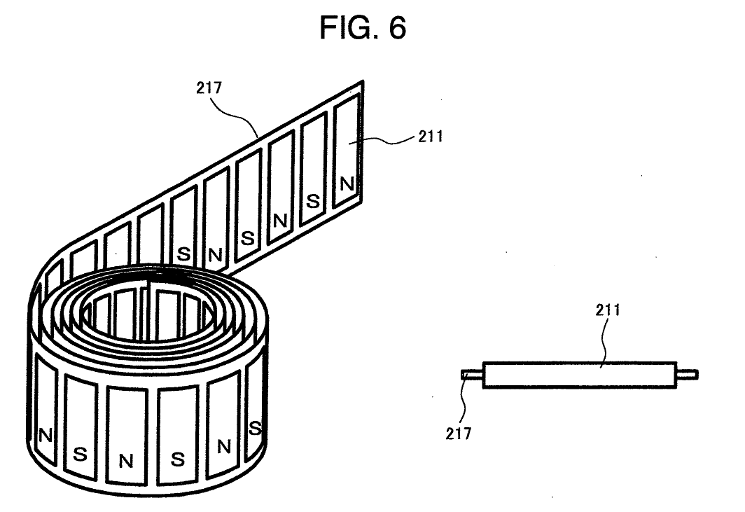

FIG. 6 illustrates a permanent magnet component used in the linear motor according to the embodiment of the present invention.

The permanent magnet component of FIG. 6 includes the permanent magnets 211 disposed in the third member 217 at regular intervals in order of N, S, N and S poles and wound into the form of roll.

The third member 217 can be formed to be thinner than the permanent magnets 211 and can be made of non-magnetic metal such as aluminum and stainless steel. Further, the third member can be made of resin material having variability or flexibility to some degree.

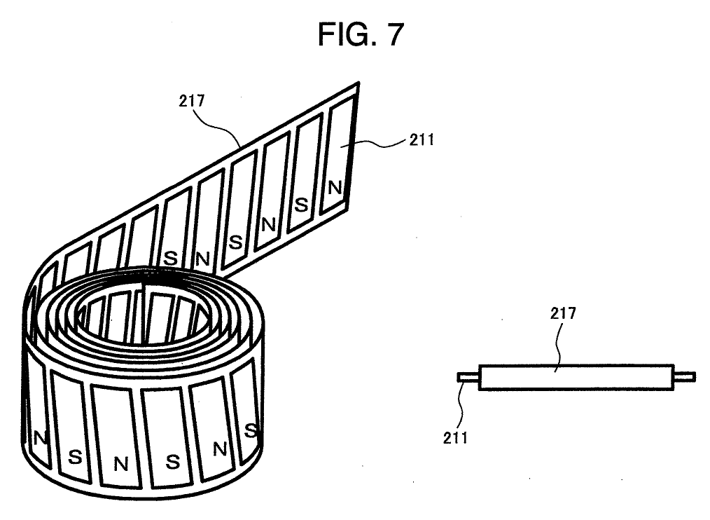

FIG. 7 illustrates an example of a permanent magnet component of a linear motor according to another embodiment of the present invention.

The permanent magnet component of FIG. 7 includes the permanent magnets 211 skewed and disposed in the third member 217 at regular intervals in order of N, S, N and S poles and wound into the form of roll.

Similarly to the embodiment of FIG. 6, the third member 217 can be formed to be thinner than the permanent magnets 211 and can be made of resin material having variability or flexibility to some degree.

As described above, the permanent magnets 211 are skewed and disposed at regular intervals, so that a ripple in propulsive force can be reduced and the moving member 210 can be moved smooth when the moving member of the secondary-side members is moved relatively.

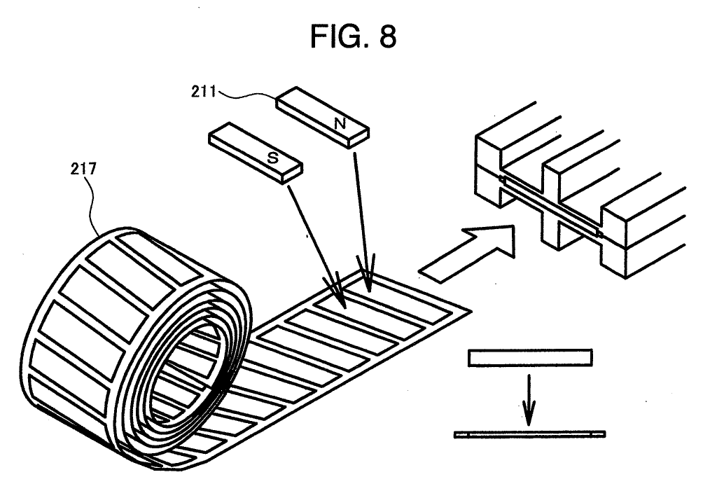

FIG. 8 illustrates an example of how to make the permanent magnet component of the linear motor according to another embodiment of the present invention.

In FIG. 8, there is shown the work of putting on the permanent magnets 211 when the third member 217 for keeping the permanent magnets 211 at regular intervals is inserted into the member having the hollow part. The third member may be inserted into the member having the hollow part while adhesive (not shown) is applied when the permanent magnets are put on or adhesive may be later poured into the member having the hollow part to be hardened. Furthermore, not only adhesive but also welding, bolt, pin and rivet may be used to fix components.

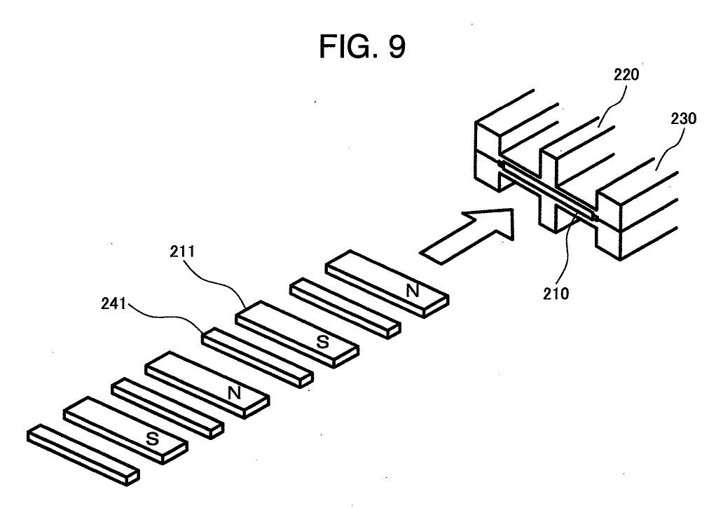

FIG. 9 illustrates an example of how to make the moving member using spacers 214 instead of the third member 217 for keeping the permanent magnets 211 at regular intervals.

FIG. 9 illustrates the work of putting on the permanent magnets 211 when the spacers 241 for keeping the permanent magnets at regular intervals are inserted into the member having the hollow part. The spacers 241 may be inserted into the member having the hollow part while adhesive (not shown) is applied when the permanent magnets are put on or adhesive may be later poured into the member having the hollow part to be hardened. Furthermore, not only adhesive but also welding, bolt, pin and rivet may be used to fix components.

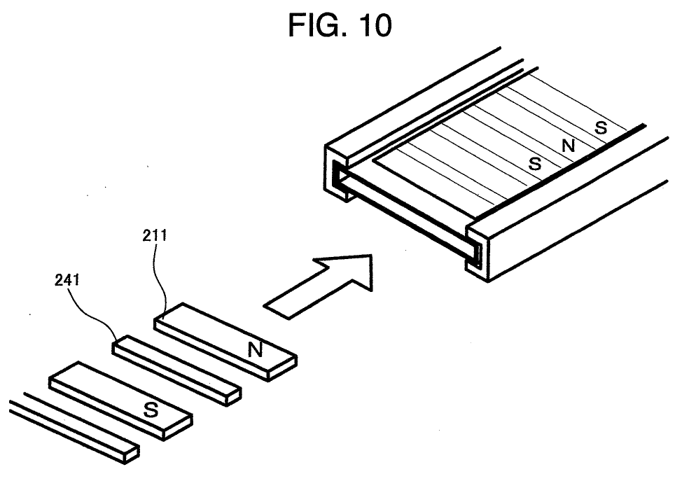

FIG. 10 illustrates an example of how to make the moving member formed by combining the permanent magnets 211 and the spacers 241 with an aluminum extruded component having no protrusion member disposed at center parts on both of the obverse and reverse sides of the moving member 210 as shown in FIG. 5(b).

Even in this embodiment, there is shown the work of putting on the permanent magnets 211 when the spacers 214 for keeping the permanent magnets 211 at regular intervals are inserted into the member having the hollow part similarly to the embodiment of FIG. 9. The spacers 241 may be inserted into the member having the hollow part while adhesive (not shown) is applied when the permanent magnets are put on or adhesive may be later poured into the member having the hollow part to be hardened. Furthermore, not only adhesive but also welding, bolt, pin and rivet may be used to fix components.

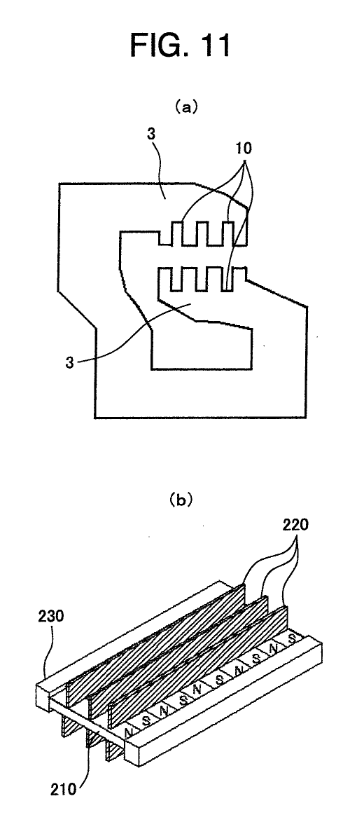

FIG. 11 illustrates the core and the moving member of the linear motor according to another embodiment of the present invention.

FIG. 11(a) shows an example of a plurality of slit grooves 10 (6 slit grooves in total including 3 slit grooves in the upper part and 3 slit grooves in the lower part are shown in FIG. 15) formed in the armature teeth 3 in part of the ring-like core opposite to both of the obverse and reverse sides of the permanent magnets of the moving member 210 through air gap. FIG. 11(b) shows an example of a plurality of protrusion members 220 disposed on both of the obverse and reverse sides of the moving member 210 in a corresponding manner to the groove form of the armature teeth. Provision of such structure more enhances the rigidity of the moving member of the secondary-side members.

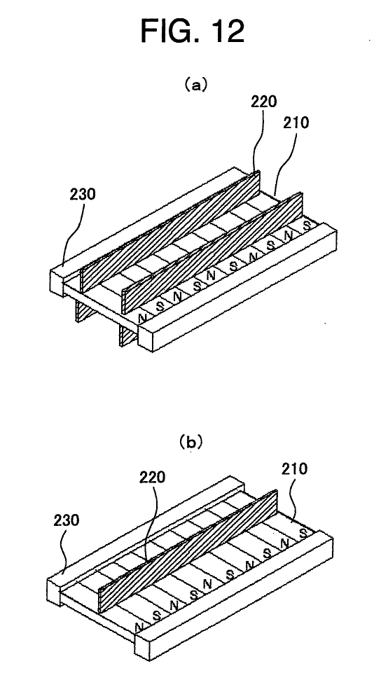

FIG. 12 shows the moving member of the linear motor according to another embodiment of the present invention.

FIG. 12(a) shows two protrusion members shifted from the center of the moving member 210 in case where a plurality of protrusion members are disposed on both of the obverse and reverse sides of the moving member 210. Even in such structure, the rigidity of the moving member can be enhanced.

Further, FIG. 12(b) shows the protrusion member disposed on one of the obverse and reverse sides of the moving member 210 along the longitudinal direction thereof. Even in such structure, the rigidity of the moving member can be enhanced.

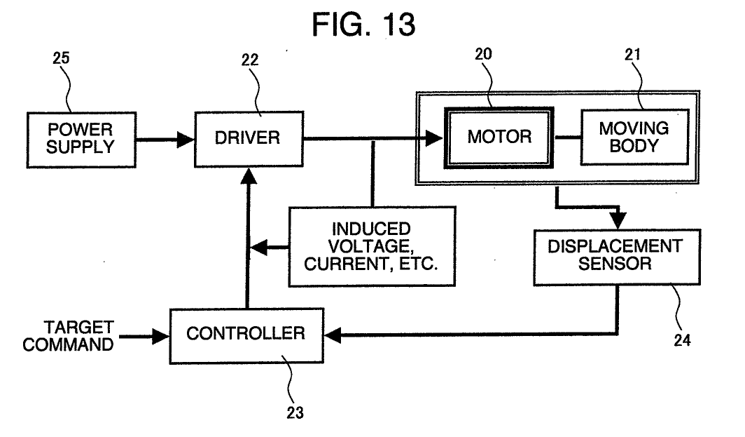

FIG. 13 is a schematic diagram illustrating a servo control system using the linear motor of the present invention.

The linear motor 20 of the present invention is connected to a moving body 21 and the system includes a driver 22, a controller 23 and a displacement sensor 24 and drives the linear motor in accordance with a target command. The system of FIG. 13 constitutes a closed loop control system using the displacement sensor 24, although the system can attain open loop control without the displacement sensor depending on use. Moreover, a current sensor, a magnetic pole detection sensor (not shown) and the like can be used to attain the servo control system having high accuracy and high performance.

In FIG. 13, the displacement sensor 24 includes an encoder scale (not shown) disposed along the longitudinal direction of the moving member 210 similarly to the prior art linear motor and an encoder detector (not shown) disposed in a corresponding manner to the encoder scale and can be used as a linear driving device.

The ring-like cores or the armature winding disposed in the armature teeth of the linear motor of the present invention has been described by way of example, although the ring-like cores and the armature winding may be combined in a mixed manner.

In the embodiments of the linear motor of the present invention as described above, the moving member is disposed on the side of the permanent magnets and the stator is disposed on the side of the armature winding, although conversely the moving member may be disposed on the side of the armature winding and the stator may be disposed on the side of the permanent magnets.

Moreover, besides the embodiments having the above-mentioned combination, only a part of the combination may be adopted. The constituent elements of the linear motor shown in the drawings may be combined across the embodiments shown in the drawings regardless of the embodiments and the combined elements may be molded.

### INDUSTRIAL APPLICABILITY

As described above, according to the present invention, there is provided the linear motor in which the arrangement method of the armature winding is devised to have compact structure and the magnetic attractive force acting between the stator and the moving member can be canceled. Moreover, there can be provided the linear motor having the enhanced rigidity of components including the permanent magnets and which can be manufactured inexpensively by simple structure.

1. A linear motor including a plurality of permanent magnets disposed along a moving direction and cores disposed opposite to both of obverse and reverse sides of the permanent magnets to form a closed magnetic path, wherein
slit grooves are formed in armature teeth of the core and
protrusion members are disposed to be able to be moved along the slit grooves,
the protrusion members including a hollow part formed therein,
a plurality of members holding one or more permanent magnets being combined to be disposed in the hollow part so that magnetic poles adjoining along the moving direction have different polarities.

2. A linear motor according to claim 1, wherein
the plurality of permanent magnets are disposed in a third member for keeping the permanent magnets at regular intervals and the third member and the permanent magnets are disposed together in the hollow part.

3. A linear motor according to claim 1, wherein
the plurality of permanent magnets are disposed in resin material and the resin material is disposed in the hollow part.

4. A linear motor according to claim 1, wherein
a third member for keeping the permanent magnets at regular intervals is formed into belt and includes spaces in which the plurality of permanent magnets are disposed and the third member and the permanent magnets are disposed in the hollow space.

5. A linear motor according to claim 1, wherein
the member having the hollow part formed therein is manufactured by aluminum extrusion and the plurality of permanent magnets are disposed in the hollow part so that magnetic poles adjoining along the moving direction have different polarities.

6. A linear motor according to claim 1, wherein
a stator is fixedly supported and a moving member is moved.

7. A linear motor according to claim 1, wherein
a moving member is fixedly supported and a stator is moved.

8. A linear motor including a plurality of permanent magnets disposed along a moving direction and cores disposed opposite to both of obverse and reverse sides of the permanent magnets to form a closed magnetic path, wherein
slit grooves are formed in armature teeth of the core and
protrusion members are disposed to be able to be moved along the slit grooves,
the protrusion members including a hollow part formed therein,
magnetic members being disposed in the hollow part.

9. A linear motor according to claim 8, wherein
the magnetic members are disposed so that magnetic poles thereof adjoining along the moving direction have different polarities.

10. A linear motor according to claim 9, wherein
the plurality of magnetic members are disposed in a third member at regular intervals and the third member and the magnetic members are disposed together in the hollow part.
